(19) United States
(12) Patent Application Publication
(10) Pub. No.: US 2014/0011616 A1
(43) Pub. Date: Jan. 9, 2014

(54) BELT-DRIVEN CONTINUOUSLY VARIABLE TRANSMISSION

(71) Applicants: Akira Ijichi, Susono-shi (JP); Toshinari Sano, Gotemba-shi (JP); Masafumi Yamamoto, Susono-shi (JP); Tatsuya Saito, Susono-shi (JP)

(72) Inventors: Akira Ijichi, Susono-shi (JP); Toshinari Sano, Gotemba-shi (JP); Masafumi Yamamoto, Susono-shi (JP); Tatsuya Saito, Susono-shi (JP)

(73) Assignee: TOYOTA JIDOSHA KABUSHIKI KAISHA, Toyota-shi, Aichi (JP)

(21) Appl. No.: 14/000,793

(22) PCT Filed: Mar. 25, 2011
(86) PCT No.: PCT/JP2011/057365

§ 371 Date: Aug. 21, 2013

(51) Int. Cl. F16H 9/12

(52) U.S. Cl. CPC F16H 9/125
USPC 474/28; 474/45

(57) ABSTRACT

A belt-driven continuously variable transmission adapted to reduce a frictional resistance between the movable sheave and the rotary shaft. The pulley includes the fixed sheave rotated integrally with the rotary shaft, and the movable sheave engaged with the rotary shaft in a manner to slide axially and to be rotated integrally with the rotary shaft. The driving belt is applied to the belt groove formed between the movable sheave and the fixed shave to transmit torque. The transmission is provided with the a passage for delivering fluid to the engagement mechanism engaging the rotary shaft with the movable sheave while allowing relative axial movement therebetween.

### TECHNICAL FIELD

The present invention relates to a belt-driven continuously variable transmission comprised of a pair of pulleys and a driving belt applied between those pulleys.

### BACKGROUND ART

A belt-driven continuously variable transmission adapted to change a speed ratio continuously using a driving belt is known in the art. The belt-driven continuously variable transmission is comprised of a primary pulley and secondary pulley arranged in parallel fashion, and a driving belt running on those pulleys to transmit power therebetween. Each of the pulleys is individually comprised of a fixed sheave integrated with a rotary shaft, and a movable sheave fitted onto the rotary shaft while being allowed to reciprocate thereon. A conical face is formed on an inner face (as will be called a “pulley face” hereinafter) of each sheave to be opposed to each other. Therefore, the driving belt being contacted to the pulley face transmits the power frictionally therebetween.

In order to allow the movable sheave to slide on the rotary shaft in the axial direction, a hollow shaft is formed integrally with the movable sheave to which the rotary shaft is inserted. For example, Japanese Patent Publication No. 3412741 discloses a belt-driven continuously variable transmission in which a hollow bush made of resin material is inserted into the hollow shaft of the movable sheave to reduce a friction resistance offered to the movable sheave sliding on the rotary shaft.

As described, the belt-driven continuously variable transmission is adapted to transmit power utilizing a friction between the pulley and the driving belt. For this purpose, in the conventional dry-type belt-driven continuously variable transmission, a lateral face of the driving belt to which the pulley face is contacted is covered with a resin film to increase a friction between the driving belt and the pulley face. Therefore, in the dry-type belt-driven continuously variable transmission of this kind, the power is transmitted frictionally without applying lubricating oil to the contact point between the driving belt and the pulley face. However, if the oil enters into the contact portion between the driving belt and the pulley face from a hydraulic actuator for pushing the movable sheave in the axial direction, a slippage may occur between the lateral face of the driving belt and the pulley face. According to the teachings of Japanese Patent Laid-Open No. 2007-203655, therefore, a sealing member such as an O-ring is disposed between the hollow shaft of the movable sheave and the rotary shaft to block the oil to enter into the contact portion between the driving belt and the pulley face from a hydraulic actuator.

Thus, in the dry-type belt-driven continuously variable transmission, the lubricating oil is not applied to the driving belt. Therefore, each sliding surfaces of sliding member is covered with resin material of high lubricity to reduce frictional resistance. However, the movable sheave is joined with the rotary shaft of the fixed sheave through a spline or key to be rotated integrally, and the resin coating may be fatigued by compressive stress or the like resulting from the torque of the joint portion. In order to avoid such disadvantage, the joint portion has to be elongated to reduce the stress acting thereon, however, a total axial length of the belt-driven continuously variable transmission is also elongated consequently.

### DISCLOSURE OF THE INVENTION

The present invention has been conceived noting the technical problems thus far described, and it is an object of this invention to provide a belt-driven continuously variable transmission adapted to reduce the frictional resistance between the movable sheave and the rotary shaft.

The present invention is applied to a belt-driven continuously variable transmission. In the belt-driven continuously variable transmission, a pulley is comprised of a fixed sheave rotated integrally with a rotary shaft, and a movable sheave engaged with the rotary shaft in a manner to slide in an axial direction and to be rotated integrally with the rotary shaft. In addition, a driving belt is applied to a belt groove formed between the movable sheave and the fixed shave to transmit torque. In order to solve the foregoing technical problems, according to the present invention, the belt-driven continuously variable transmission is provided with a lubrication passage that allows fluid to flow through an engagement mechanism engaging the rotary shaft with the movable sheave while allowing relative axial movement therebetween.

According to the present invention, the lubrication passage is comprised of a feeding port and a drain port opening toward the engagement mechanism.

The belt-driven continuously variable transmission of the present invention is further comprised of a first passage formed in the rotary shaft having an opening formed on an outer circumferential face of the rotary shaft. In addition, the feeding port includes the opening of the first passage formed on the outer circumferential face of the rotary shaft.

Specifically, the movable sheave is comprised of a hollow shaft that protrudes in an opposite direction of the belt groove and that is engaged with the rotary shaft. A second passage is formed in the hollow shaft in a manner to penetrate the hollow shaft from an inner circumferential face to an outer circumferential face so as to open to the engagement mechanism. The drain port includes an opening of the second passage of the engagement mechanism side.

An end portion of the rotary shaft of the movable sheave side is held in a rotatable manner by a bearing, and the fluid is allowed to flow from the drain port toward the bearing through a flow path.

In addition, according to the present invention, a sealing member is interposed between the movable sheave and the rotary shaft to prevent the fluid from entering into the belt groove from the engagement mechanism.

The belt-driven continuously variable transmission of the present invention is further comprised of a hydraulic actuator arranged on a leading end side of the hollow shaft to apply a thrust force to the movable sheave toward the fixed sheave, a housing accommodating the hollow shaft and the hydraulic actuator, and a fluid chamber formed inside of the housing. Here, the second passage is opened toward the fluid chamber.

The hydraulic actuator is comprised of: a piston formed integrally with a leading end portion of the hollow shaft; a cylindrical member in which the piston is brought into contact to an inner circumferential face slidably and liquid-tightly; a pressure chamber formed between the piston and the cylindrical member; and a feeding passage formed in the rotary shaft to deliver and drain the fluid to/from the pressure chamber.

According to the present invention, the pulley includes a dry-type pulley adapted to transmit torque without applying lubricant between the driving belt and the pulley.

Further, according to the present invention, the engagement mechanism includes any of a key and a spline.

Thus, according to the present invention, the pulley is comprised of a fixed sheave rotated integrally with a rotary shaft, and a movable sheave engaged with the rotary shaft in a manner to slide in an axial direction and to be rotated integrally with the rotary shaft. Accordingly, a speed ratio of the belt-driven continuously variable transmission is changed by moving the movable sheave in the axial direction thereby displacing an effective diameter position of the driving belt held in the belt groove. In addition, the belt-driven continuously variable transmission is provided with the lubrication passage for delivering the fluid to the engagement mechanism slidably engaging the rotary shaft with the movable sheave. Therefore, the frictional resistance resulting from sliding the movable sheave on the rotary shaft can be reduced. Consequently, not only a power loss but also a frictional heat resulting from moving the movable sheave can be reduced.

As described, the lubrication passage is comprised of the feeding port and the drain port opening toward the engagement mechanism. Therefore, the lubricant will not remain in the engagement mechanism so that the engagement mechanism can be cooled efficiently.

In addition, the belt-driven continuously variable transmission of the present invention is further comprised of the first passage formed in the rotary shaft having an opening formed on an outer circumferential face of the rotary shaft, and the feeding port includes the opening of the first passage formed on the outer circumferential face of the rotary shaft. Therefore, flow of the lubricant toward the engagement mechanism can be promoted centrifugally by rotating the rotary shaft.

As also described, the movable sheave is integrated with the hollow shaft that protrudes in an opposite direction of the belt groove and that is engaged with the rotary shaft. The second passage is formed in the hollow shaft in a manner to penetrate the hollow shaft from an inner circumferential face to an outer circumferential face so as to open to the engagement mechanism, and the drain port includes the opening of the second passage of the engagement mechanism side. Therefore, the lubricant in the engagement mechanism is drained centrifugally from the second passage by rotating the hollow shaft together with the rotary shaft. Thus, the lubricant is allowed to flow smoothly so that the lubricant will not remain in the engagement mechanism. For this reason, the engagement mechanism can be cooled efficiently.

Moreover, according to the present invention, the end portion of the rotary shaft of the movable sheave side is held in a rotatable manner by the bearing, and the fluid is allowed to flow from the drain port toward the bearing through the flow path. Thus, the bearing can be lubricated to reduce a frictional resistance.

Still moreover, the sealing member is interposed between the movable sheave and the rotary shaft to block the lubricant from the engagement mechanism to enter into the belt groove. Therefore, the lubricant will not degrade torque transmitting efficiency.

As also described, the belt-driven continuously variable transmission of the present invention is further comprised of the hydraulic actuator arranged on the leading end side of the hollow shaft to apply a thrust force to the movable sheave toward the fixed sheave, the housing accommodating the hollow shaft and the hydraulic actuator, and the fluid chamber formed inside of the housing. In addition, the second passage is opened toward the fluid chamber. Therefore, the lubricant in the engagement mechanism is allowed to be drained to the fluid chamber instead of the belt groove, without degrading torque transmitting efficiency.

As also described, the hydraulic actuator is comprised of: the piston formed integrally with the leading end portion of the hollow shaft; the cylindrical member in which the piston is brought into contact to the inner circumferential face slidably and liquid-tightly; the pressure chamber formed between the piston and the cylindrical member; and the feeding passage formed in the rotary shaft to deliver and drain the fluid to/from the pressure chamber. Therefore, the movable sheave can be moved integrally with the piston by changing an internal pressure of the pressure chamber.

Further, according to the present invention, the pulley includes the dry-type pulley adapted to transmit torque without applying the lubricant between the driving belt and the pulley. Therefore, a frictional force can be created between the pulley face and the driving belt by a relatively small thrust force.

Furthermore, the engagement mechanism includes any of the key and the spline. That is, according to the present invention, the movable sheave can be engaged with the rotary shaft using the conventional mechanism.

### BRIEF DESCRIPTION OF THE DRAWINGS

FIG. 1 is a view schematically showing a preferred example of the belt-driven continuously variable transmission according to the present invention.

FIG. 2 is a view schematically showing a preferred example of a power train of the vehicle having the belt-driven continuously variable transmission of the present invention.

### BEST MODE FOR CARRYING OUT THE INVENTION

Next, a preferred example of the belt-driven continuously variable transmission according to the present invention will be explained hereinafter. Referring now to FIG. 2, there is shown a power train of a vehicle in which the belt-driven continuously variable transmission 1 of the present invention is arranged. As shown in FIG. 2, torque of a prime mover 2 such as an engine and an electric motor is transmitted to the belt-driven continuously variable transmission 1. The belt-driven continuously variable transmission 1 is adapted to change the torque or a speed inputted thereto, and the changed torque is further transmitted to wheels 5 through a counter gear unit 3 and a differential gear unit 4. A fundamental structure of the belt-driven continuously variable transmission 1 is similar to the conventional belt-driven CVT. Specifically, the belt-driven continuously variable transmission 1 is comprised of a primary pulley 6 rotated by the power from the prime mover 2, a secondary pulley 7 arranged in parallel with the primary pulley 6, and a driving belt 8 applied to those pulleys 6 and 7. Therefore, the secondary pulley 7 is rotated by the power transmitted from the primary pulley 6 through the driving belt 8.

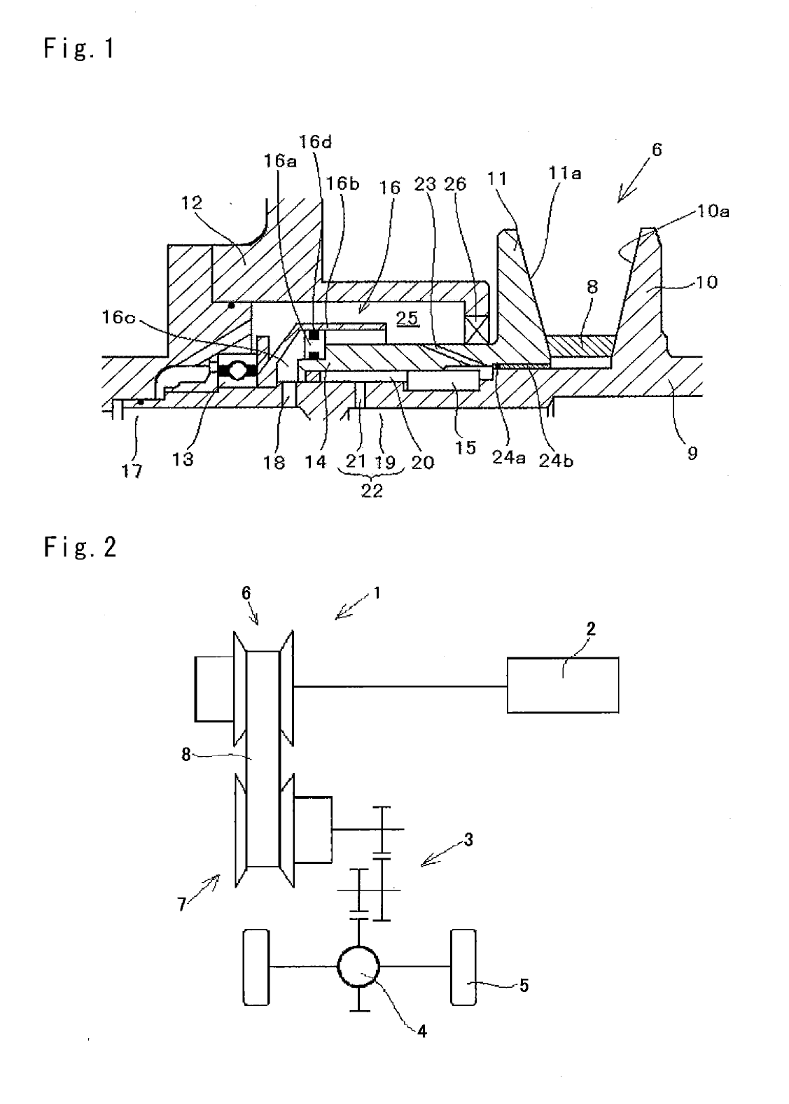

Here will be explained a structure of each pulleys 6 and 7 in more detail with reference to FIG. 1. However, structures of the primary pulley 6 and the secondary pulley 7 are substantially identical to each other. Therefore, only a partial cross-section of the primary pulley 6 is illustrated in FIG. 1. As shown in FIG. 1, the primary pulley 6 is comprised of a fixed sheave 10 integrated with an input shaft 9 connected to the prime mover 2, and a movable sheave 11 fitted onto the input shaft 9 while being allowed to reciprocate in the axial direction with respect to the fixed sheave 10. The input shaft 9 is held in a rotatable manner by a bearing 13 disposed on a housing 12. Those sheaves 10 and 11 are individually provided with a conical face (as will be called pulley faces 10a, 11a hereinafter), and those pulley faces 10a and 11a are opposed to each other to form a groove for holding the driving belt 8. Therefore, the power is transmitted frictionally between the pulley face 10a or 11a and a lateral face of the driving belt 8 contacted thereto. In the preferred example shown in FIG. 1, at least both lateral faces of the driving belt 8 are covered individually with a resin film made of synthetic resin material of large friction coefficient thereby increasing friction between the pulley face 10a or 11a and the lateral face of the driving belt 8. Here, lubricant will not be applied to the contact face between the pulley face 10a or 11a and the lateral face of the driving belt 8 during transmitting the power.

The movable sheave 11 have a hollow structure in its central portion and the input shaft 9 is inserted into the hollow portion so that the movable sheave 11 is allowed to reciprocate on the input shaft 9 in the axial direction. Specifically, the movable sheave 11 is formed integrally with a hollow shaft 14 protruding in the opposite direction of the pulley face 11a, and the input shaft 9 is inserted into the hollow shaft 14. An inner circumferential face of the hollow shaft 14 is engaged with an outer circumferential face of the input shaft 9 through an engagement mechanism 15 such as an involute spline, a ball spline, a key and so on. Therefore, the movable sheave 11 is allowed to rotate integrally with the fixed sheave 10 and to reciprocate on the input shaft 9 in the axial direction. To this end, for example, a groove(s) is/are formed on any of the inner circumferential face of the hollow shaft 14 and the outer circumferential face of the input shaft 9 in a predetermined length along the axial direction, and a ridge(s) meshed with the groove(s) is/are formed on the other face.

In order to move the movable sheave 11 in the axial direction, a hydraulic actuator 16 is arranged on a leading end side of the hollow shaft 14. Specifically, the hydraulic actuator 16 is adapted to push the movable sheave 11 toward the fixed sheave 10. For this purpose, the hydraulic actuator 16 is comprised of a piston 16a protruding toward the outer circumferential side from the leading end of the hollow shaft 14, and a cylinder 16b formed around the leading end of the hollow shaft 14. Accordingly, a pressure chamber 16c is formed by the leading end portion of the hollow shaft 14, the piston 16a and the cylinder 16b. In order to push the movable sheave 11 toward the fixed sheave 10, the hydraulic fluid is delivered to the pressure chamber 16c thereby applying an axial load to the leading end portion of the hollow shaft 14 and the piston 16a. To this end, a bore 17 is formed in the input shaft 9 along the center axis from the left end of FIG. 1 to a site of an inner circumferential side of the hydraulic actuator 16, and a through hole 18 is formed to provide a fluid communication between the bore 17 and the pressure chamber 16c. Thus, the bore 17 and the through hole 18 form a feeding passage for delivering the fluid from a not shown pump to the pressure chamber 16c and draining the fluid from the pressure chamber 16c. In addition, in order to prevent a leakage of the fluid from the pressure chamber 16c, a sealing member 16d such as an O-ring is disposed between the outer circumferential face of the piston 16a and the inner circumferential face of the cylinder 16b.

As described, the thrust force for pushing the movable sheave 11 of the pulley 6 in the axial direction is changed by changing the hydraulic pressure in the hydraulic actuator 16. Therefore, a width of the belt groove formed by the pulley face 11a of the movable sheave 11 and the pulley face 10a of the fixed sheave 10 can be changed by thus moving the movable sheave 11 hydraulically in the axial direction. However, the movable sheave 11 is fitted onto the input shaft 9 through the engagement mechanism 15, therefore, a frictional resistance will act on the contact face in the engagement mechanism 15 against the thrust force applied to the movable sheave 11.

In order to reduce such frictional resistance resulting from moving the movable sheave 11 in the axial direction, according to the belt-driven continuously variable transmission 1 of the present invention, the lubricant is delivered to the engagement mechanism 15. A preferred example of a structure for delivering the lubricant to the engagement mechanism 15 will be explained hereinafter. A bore 19 is formed in the input shaft 9 along the center axis from the right end of FIG. 1 to near an intermediate portion, and a through hole 21 is formed in the input shaft 9 at a site of the inner circumferential side of a clearance 20 existing between the inner circumferential face of the hollow shaft 14 and the outer circumferential face of the input shaft 9, so as to provide a fluid communication between the bore 19 and the clearance 20. Thus, in the preferred example shown in FIG. 1, the through hole 21 is formed in a manner to open to the left side of the engagement mechanism 15. Accordingly, the lubricant is introduced to the engagement mechanism 15 from a not shown oil pump connected to the bore 19 through the through hole 21 and the clearance 20. Thus, the bore 19 and the through hole 21 serve as a passage 22 for delivering the lubricant to the engagement mechanism 15.

In order to prevent the lubricant from remaining in the engagement mechanism 15, an outlet 23 is formed in the hollow shaft 14 to provide a fluid communication between the inner circumferential side and the outer circumferential side of the hollow shaft 14. In the preferred example shown in FIG. 1, the outlet 23 is formed in a manner to open to the right side of the engagement mechanism 15. Therefore, the lubricant delivered to the engagement mechanism 15 is allowed to drain to the outer circumferential side of the hollow shaft 14 through the clearance of the engagement mechanism 15, that is, the clearance between the ridge formed on any of the input shaft 9 and the hollow shaft 14 and the groove formed on the other one. In order to prevent the lubricant from entering into the belt groove, a bush 24b made of resin material is inserted into the clearance between the inner circumferential face of the movable sheave 11 and the outer circumferential face of the input shaft 9, and in addition, a seal member 24a such as an O-ring is disposed to close the clearance.

Thus, the passage 22 is formed to deliver the lubricant to the engagement mechanism 15, and the outlet 23 is formed to drain the lubricant passing through the engagement mechanism 15. Therefore, the lubricant is allowed not only to be delivered to the engagement mechanism 15 but also to be drained out of the engagement mechanism 15. For this reason, it is possible to reduce the frictional resistance of the engagement mechanism 15, and in addition, the engagement mechanism 15 can be cooled efficiently. That is, both of the passage 22 and the outlet 23 are adapted to provide fluid communication with the outer circumferential side of the rotational center axis. Therefore, the stream of the lubricant in the passage 22 and the outlet 23 is expedited by the centrifugal force.

As described, the belt-driven continuously variable transmission 1 is adapted to transmit the power without applying the lubricant to the contact face between the driving belt 8 and the pulley face 10a or 11a. Meanwhile, the housing 12 is adapted to temporarily retain the fluid leaking from the clearance between the cylinder 16b and the piston 16a of the actuator 16 and the lubricant draining from the engagement mechanism 15, and to drain the retained fluid to a not shown oil pan or the like. Specifically, the lubricant or the fluid is delivered to a fluid chamber 25 of the housing 12 accommodating the hollow shaft 14 and the hydraulic actuator 16, and drained from a not shown drain port formed in the lower portion of the housing 12 by gravity. In addition, a sealing member 26 is disposed between the housing 12 and the outer circumferential face of the hollow shaft 14 to prevent a leakage of the lubricant from the fluid chamber 25. An internal pressure of the fluid chamber 25 thus structured is substantially equal to an atmospheric pressure. Therefore, a pressure in the discharge side of the outlet 23 of the hollow shaft 14 is reduced so that the stream of the lubricant is facilitated.

As also described, the input shaft 9 is held in a rotatable manner by the bearing 13 disposed on the housing 12. Therefore, the lubricant in the fluid chamber 25 may also be delivered to the bearing 13 for the purpose of lubrication. In this case, the fluid chamber 25 serves as a flow path, and the lubricant is delivered to the bearing 13 through an inner wall of the fluid chamber 25 or an outer circumferential face of the cylinder 16b. That is, an open bearing may be used as the bearing 13 by thus delivering the lubricant thereto. Consequently, power transmitting efficiency of the belt-driven continuously variable transmission 1 can be improved.

According to the belt-driven continuously variable transmission 1 of the present invention, the lubricant is thus delivered to the engagement mechanism 15 and the lubricant is allowed to flow therethrough. However, for example, the lubricant may also be delivered to the engagement mechanism 15 from the housing 12 side, and drained from the input shaft 9. Alternatively, the lubricant may also be drained by forming a plurality of passages in the input shaft 9. In this case, an oil pump is connected to one of the passages and remaining passages are used to drain the lubricant.

In the foregoing example, the present invention is applied to the primary pulley 6, however, the present invention may also be applied to the secondary pulley 7. In addition, the present invention may be applied not only to the dry-type pulley adapted to transmit power by the friction between the belt 8 and the pulley face 10a or 11a without lubricant, but also to a wet-type pulley in which the lubricant is applied to the belt 8 and the pulley faces 10a and 11a.

In addition, the belt-driven continuously variable transmission 1 of the present invention may be used not only in automobiles but also in industrial machineries, aircrafts, ships, vessels and so on.

1-11. (canceled)

12. A belt-driven continuously variable transmission,
in which a pulley is comprised of a fixed sheave rotated integrally with a rotary shaft, and a movable sheave engaged with the rotary shaft in a manner to slide in an axial direction and to be rotated integrally with the rotary shaft, and
in which a driving belt is applied to a belt groove formed between the movable sheave and the fixed shave to transmit torque, comprising:
an engagement mechanism that engages the rotary shaft with the movable sheave while allowing relative axial movement therebetween;
a lubrication passage that allows fluid to flow through the engagement mechanism;
a feeding port opening to one side of the engagement mechanism to introduce the fluid to the lubrication passage;
a drain port that drain the fluid in the lubrication passage to an atmospheric area from the other side of the engagement mechanism; and
a sealing member disposed between the lubrication passage and the belt groove to block the fluid to enter into the belt groove.

13. The belt-driven continuously variable transmission as claimed in claim 12, further comprising:
a first passage formed in the rotary shaft having an opening formed on an outer circumferential face of the rotary shaft; and
wherein the feeding port includes the opening of the first passage formed on the outer circumferential face of the rotary shaft.

14. The belt-driven continuously variable transmission as claimed in claim 12, wherein:
the movable sheave comprises a hollow shaft that protrudes in an opposite direction of the belt groove and that is engaged with the rotary shaft;
a second passage is formed in the hollow shaft in a manner to penetrate the hollow shaft from an inner circumferential face to an outer circumferential face so as to open to the engagement mechanism; and
the drain port includes an opening of the second passage of the engagement mechanism side.

15. The belt-driven continuously variable transmission as claimed in claim 14, further comprising:
a hydraulic actuator arranged on a leading end side of the hollow shaft to apply a thrust force to the movable sheave toward the fixed sheave;
a housing accommodating the hollow shaft and the hydraulic actuator; and
a fluid chamber formed inside of the housing;
wherein the second passage is opened toward the fluid chamber.

16. A belt-driven continuously variable transmission,
in which a pulley is comprised of a fixed sheave rotated integrally with a rotary shaft, and a movable sheave engaged with the rotary shaft in a manner to slide in an axial direction and to be rotated integrally with the rotary shaft, and in which a driving belt is applied to a belt groove formed between the movable
sheave and the fixed shave to transmit torque, comprising:
a lubrication passage that allows fluid to flow through an engagement mechanism engaging the rotary shaft with the movable sheave while allowing relative axial movement therebetween;
wherein the lubrication passage is comprised of a feeding port and a drain port opening toward the engagement mechanism;
further comprising a first passage formed in the rotary shaft having an opening formed on an outer circumferential face of the rotary shaft;
wherein the feeding port includes the opening of the first passage formed on the outer circumferential face of the rotary shaft;
wherein the movable sheave comprises a hollow shaft that protrudes in an opposite direction of the belt groove and that is engaged with the rotary shaft;
wherein a second passage is formed in the hollow shaft in a manner to penetrate the hollow shaft from an inner circumferential face to an outer circumferential face so as to open to the engagement mechanism;
wherein the drain port includes an opening of the second passage of the engagement mechanism side; and
further comprising a hydraulic actuator arranged on a leading end side of the hollow shaft to apply a thrust force to the movable sheave toward the fixed sheave;
a housing accommodating the hollow shaft and the hydraulic actuator; and
a fluid chamber formed inside of the housing;
wherein the second passage is opened toward the fluid chamber.

17. A belt-driven continuously variable transmission,
in which a pulley is comprised of a fixed sheave rotated integrally with a rotary shaft, and a movable sheave engaged with the rotary shaft in a manner to slide in an axial direction and to be rotated integrally with the rotary shaft, and
in which a driving belt is applied to a belt groove formed between the movable sheave and the fixed shave to transmit torque, comprising:
a lubrication passage that allows fluid to flow through an engagement mechanism engaging the rotary shaft with the movable sheave while allowing relative axial movement therebetween;
wherein the lubrication passage is comprised of a feeding port and a drain port opening toward the engagement mechanism;
wherein the movable sheave comprises a hollow shaft that protrudes in an opposite direction of the belt groove and that is engaged with the rotary shaft;
wherein a second passage is formed in the hollow shaft in a manner to penetrate the hollow shaft from an inner circumferential face to an outer circumferential face so as to open to the engagement mechanism;
wherein the drain port includes an opening of the second passage of the engagement mechanism side;
further comprising a hydraulic actuator arranged on a leading end side of the hollow shaft to apply a thrust force to the movable sheave toward the fixed sheave;
a housing accommodating the hollow shaft and the hydraulic actuator; and
a fluid chamber formed inside of the housing;
wherein the second passage is opened toward the fluid chamber.

18. The belt-driven continuously variable transmission as claimed in claim 16, further comprising:
a sealing member interposed between the movable sheave and the rotary shaft to prevent the fluid from entering into the belt groove from the engagement mechanism.

19. The belt-driven continuously variable transmission as claimed in claim 15, wherein the hydraulic actuator is comprised of:
a piston formed integrally with a leading end portion of the hollow shaft;
a cylindrical member in which the piston is brought into contact to an inner circumferential face slidably and liquid-tightly;
a pressure chamber formed between the piston and the cylindrical member; and
a feeding passage formed in the rotary shaft to deliver and drain the fluid to/from the pressure chamber.

20. The belt-driven continuously variable transmission as claimed in claim 12, further comprising:
a bearing holding an end portion of the rotary shaft of the movable sheave side in a rotatable manner; and
a flow path that allows the fluid to flow from the drain port toward the bearing.

21. The belt-driven continuously variable transmission as claimed in claim 12, wherein the pulley includes a dry-type pulley adapted to transmit torque without applying lubricant between the driving belt and the pulley.

22. The belt-driven continuously variable transmission as claimed in claim 12, wherein the engagement mechanism includes any of a key and a spline,

23. The belt-driven continuously variable transmission as claimed in claim 13, wherein:
the movable sheave comprises a hollow shaft that protrudes in an opposite direction of the belt groove and that is engaged with the rotary shaft;
a second passage is formed in the hollow shaft in a manner to penetrate the hollow shaft from an inner circumferential face to an outer circumferential face so as to open to the engagement mechanism; and
the drain port includes an opening of the second passage of the engagement mechanism side.

24. The belt-driven continuously variable transmission as claimed in claim 23, further comprising:
a hydraulic actuator arranged on a leading end side of the hollow shaft to apply a thrust force to the movable sheave toward the fixed sheave;
a housing accommodating the hollow shaft and the hydraulic actuator; and
a fluid chamber formed inside of the housing;
wherein the second passage is opened toward the fluid chamber.

25. The belt-driven continuously variable transmission as claimed in claim 17, further comprising:
a sealing member interposed between the movable sheave and the rotary shaft to prevent the fluid from entering into the belt groove from the engagement mechanism.

26. The belt-driven continuously variable transmission as claimed in claim 16, wherein the hydraulic actuator is comprised of
a piston formed integrally with a leading end portion of the hollow shaft;
a cylindrical member in which the piston is brought into contact to an inner circumferential face slidably and liquid-tightly;
a pressure chamber formed between the piston and the cylindrical member; and
a feeding passage formed in the rotary shaft to deliver and drain the fluid to/from the pressure chamber.

27. The belt-driven continuously variable transmission as claimed in claim 17, wherein the hydraulic actuator is comprised of:
a piston formed integrally with a leading end portion of the hollow shaft;
a cylindrical member in which the piston is brought into contact to an inner circumferential face slidably and liquid-tightly;
a pressure chamber formed between the piston and the cylindrical member; and
a feeding passage formed in the rotary shaft to deliver and drain the fluid to/from the pressure chamber.

28. The belt-driven continuously variable transmission as claimed in claim 16, further comprising:
a bearing holding an end portion of the rotary shaft of the movable sheave side in a rotatable manner; and
a flow path that allows the fluid to flow from the drain port toward the bearing.

29. The belt-driven continuously variable transmission as claimed in claim 17, further comprising:
a bearing holding an end portion of the rotary shaft of the movable sheave side in a rotatable manner; and
a flow path that allows the fluid to flow from the drain port toward the bearing.

30. The belt-driven continuously variable transmission as claimed in claim 16, wherein the pulley includes a dry-type pulley adapted to transmit torque without applying lubricant between the driving belt and the pulley.

31. The belt-driven continuously variable transmission as claimed in claim 17, wherein the pulley includes a dry-type pulley adapted to transmit torque without applying lubricant between the driving belt and the pulley.
